(19) United States
(12) Patent Application Publication
(10) Pub. No.: US 2020/0160369 A1
(43) Pub. Date: May 21, 2020

(54) LOYALTY REWARD SELECTION AND MANAGEMENT

(71) Applicant: Sezzle, Inc., Minneapolis, MN (US)

(72) Inventors: Charles Ghassan Youakim, Minneapolis, MN (US); Paul Victor John Paradis, Minneapolis, MN (US)

(21) Appl. No.: 16/729,292

(22) Filed: Dec. 27, 2019

Related U.S. Application Data
(63) Continuation of application No. 15/794,901, filed on Oct. 26, 2017, now abandoned.

(51) Int. Cl. G06Q 30/02; G06Q 20/40

(52) U.S. Cl. CPC G06Q 30/0229; G06Q 20/4014

(57) ABSTRACT

A system for managing a loyalty reward program includes a server module configured to receive transaction requests from a plurality of merchant devices. Each transaction request includes transaction data comprising a customer identifier, a merchant identifier, a tender selection and an amount. A transaction processing module is operatively coupled with the server module and is configured to process the transaction data to identify a currency amount and at least one of a redemption amount as a function of the customer identifier and a reward amount as a function of the tender selection. A financial account access module is configured to access a financial account associated with the customer identifier and debit the currency amount from the financial account. Furthermore, a reward allocation module is configured to access a loyalty account associated with the customer identifier and apply a credit to the loyalty account based on the reward amount and the tender selection and apply a debit to the loyalty account based on the redemption amount.

### BACKGROUND

Current reward programs provide consumers with a percentage cashback on purchases that are associated with a particular merchant or card. While these programs provide consumers with incentives, the programs lack flexibility and lack the opportunity to steer customers to a particular tender selection during a transaction.

### SUMMARY

A system for managing a loyalty reward program includes a server module configured to receive transaction requests from a plurality of merchant devices. Each transaction request includes transaction data comprising a customer identifier, a merchant identifier, a tender selection and an amount. A transaction processing module is operatively coupled with the server module and is configured to process the transaction data to identify a currency amount and at least one of a redemption amount as a function of the customer identifier and a reward amount as a function of the tender selection. A financial account access module is configured to access a financial account associated with the customer identifier and debit the currency amount from the financial account. Furthermore, a reward allocation module is configured to access a loyalty account associated with the customer identifier and apply a credit to the loyalty account based on the reward amount and the tender selection and apply a debit to the loyalty account based on the redemption amount.

### BRIEF DESCRIPTION OF THE DRAWINGS

FIG. 1 is a flow diagram of a method for obtaining transaction information for a loyalty reward management system.

FIG. 2 is a flow diagram of a method for processing a transaction in a loyalty reward management system.

FIG. 3 is a schematic block diagram of devices in communication with a loyalty reward management system.

FIG. 4 is a detailed block diagram of a loyalty reward management system.

FIG. 5 is a schematic diagram of a customer dashboard of a loyalty reward management system.

### DESCRIPTION OF THE PREFERRED EMBODIMENTS

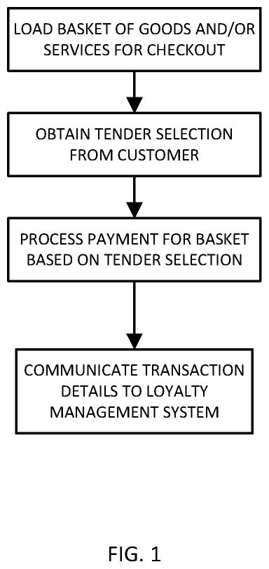

FIG. 1 is a flow diagram of a method 100 of obtaining information of a transaction for use in a loyalty reward management system. Method 100 begins at step 102, wherein a basket of goods and/or services is loaded for checkout. In one example, the basket could be loaded at a mobile device, point of sale, desktop computer or other location. Next, at step 104, a tender selection is obtained from a customer. The tender selection can include a checking account, savings account, credit card, debit card, combination of accounts, cash etc. in order to provide currency for the transaction. In one embodiment, the tender selection includes a loyalty reward account that offers a discount on transactions for a particular merchant or if particular conditions regarding the transaction have been satisfied. Additionally, the loyalty reward account may be linked with a financial account associated with a customer. In one alternative embodiment, the loyalty reward account can be pre-established between a customer and a loyalty reward management system, with the customer not having a corresponding loyalty account with the merchant. In such a situation, a customer can opt into creating a loyalty account with the particular merchant. At step 106, payment for the basket is processed based on the tender selection. Once the transaction is processed, transaction details are communicated to a loyalty management system at step 108.

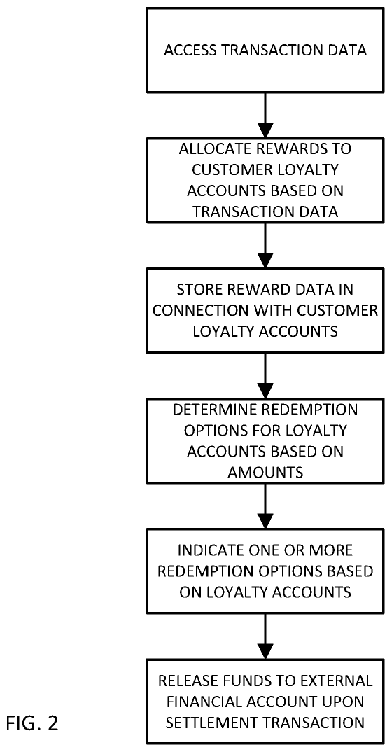

FIG. 2 is a flow diagram of a method 150 for processing transactions in a loyalty reward program. The method 150 begins at step 152 wherein transaction data is accessed, for example as received from method 100 of FIG. 1. The transaction data, in one embodiment, includes a customer identifier, a merchant identifier, a tender selection and an amount. Next, at step 154, rewards are allocated to a customer loyalty account based on the transaction data. For example, a user may have selected to receive a percentage cash back to a financial account associated with the user. A loyalty account that records and keeps track of this information can accordingly be updated based on this selection. Alternatively, a user may have selected to receive a percentage discount at a particular merchant. In this example, the percentage discount can be allocated to a merchant-specific loyalty account associated with the user. At step 156, reward data is stored in connection with the customer loyalty accounts. At step 158, redemption options are determined for the loyalty accounts based on the amounts and one or more redemption options are indicated based on the loyalty accounts at step 160. Funds are released to an external financial account based upon a settlement transaction at step 162.

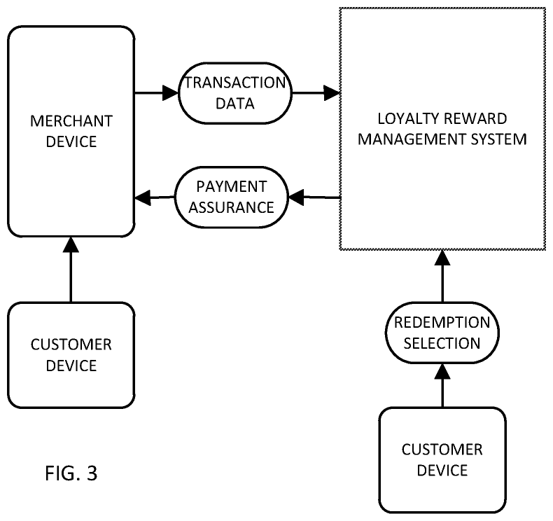

FIG. 3 is a block diagram of a loyalty reward management system 200. The loyalty reward management system 200 receives information from one or more merchant devices 202, for example a point of sale device. The information received is associated with a particular transaction. This transaction data is indicated at 204 and includes information as discussed above. A customer device 206 can communicate with the merchant device 202, for example, by providing a customer identifier and can also provide a redemption selection 208 directly to the loyalty reward management system 200. In one embodiment, the redemption selection 208 can be a discount for a particular merchant or cashback as desired. In any event, after the transaction, the system 200 can provide payment assurance 210 to the merchant device 202 such that the merchant can be assured of payment on behalf of the customer.

In one example, the transaction data includes: (1) Customer A, (2) Merchant B, (3) Payment Method C and (4) Amount of $50.00. The loyalty reward management system 200 can determine from (1) what accounts are associated with Customer A, from (2) whether Customer A has a merchant-specific account with Merchant B, from (3) what rewards should be allocated based on Payment Method C and from (4) how much reward to allocate based on the amount. Additionally, in an alternative embodiment, the loyalty reward management system 200 can determine a redemption amount if the customer has indicated a desire to receive a discount at the Merchant B. In one scenario, Payment Method C is associated with receiving a 5% discount at Merchant B. Accordingly, system 200 can apply the discount ($2.50) and provide assurance of payment for the remaining ($47.50) to the Merchant B. In one embodiment, if Customer A does not have a loyalty account with Merchant B, the loyalty reward management system 200 can automatically establish a loyalty account and provide discounts and/or rewards to the newly established account.

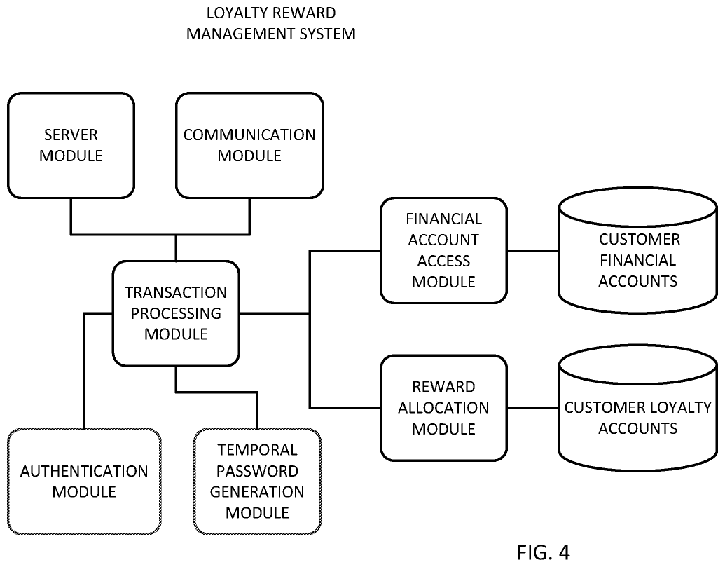

FIG. 4 is a block diagram of the loyalty reward management system 200. The system 200 includes a transaction processing module 250 that is configured to process transactions associated with a customer and a merchant. In particular, the transaction processing module 250 receives information from a server module 252 that includes information regarding a transaction. The transaction processing module 250 can further utilize a communication module 254 to communicate with different devices. Additionally, an authentication module 256 and a temporal password generation module 258 are utilized by a transaction processing module 250 so as to enhance security. For example, the temporal password generation module 258 can generate a password that is sent to a user. The authentication module 256 can be utilized to perform an authentication process to determine if a candidate password submitted by the user matches the password generated by module 258. Based on transaction information received to the transaction processing module 250, a financial account access module 260 and/or a reward allocation module 262 can be utilized so as to process transactions. The financial account access module 260 has access to customer financial accounts 264. Additionally, reward allocation module 262 has access to customer loyalty accounts 266. The access module 260 can make adjustments to the accounts 264 and 266 based on the transaction data.

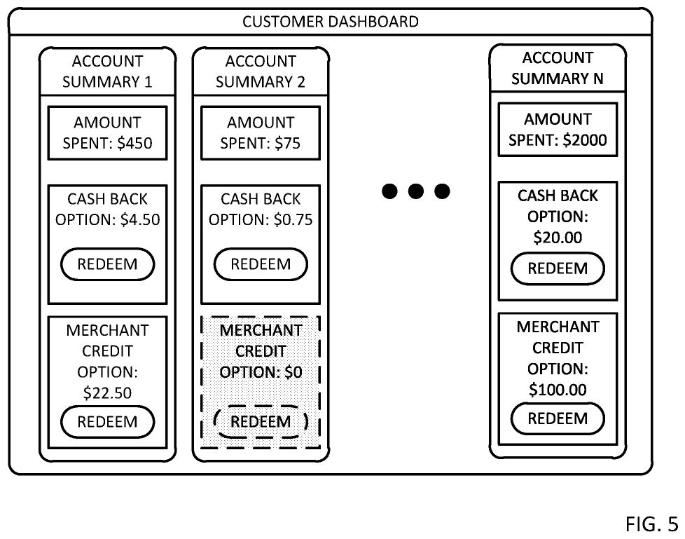

FIG. 5 is a schematic diagram of a customer dashboard 300 that can be utilized by system 200 for presenting data to a user regarding a number of loyalty accounts. The dashboard 300 shows a number of different accounts and various options for redemption. In one embodiment, a cashback option includes a particular percentage of the amount spent at a particular merchant. Moreover, the merchant credit option provides a different percentage for redemption based on an amount spent at a merchant. In some instances, a particular redemption option is disabled since an amount spent has not reached a particular threshold. For example, Account Summary 2 of the dashboard 300 the merchant credit option is disabled since the amount spent has not exceeded a threshold.

Various embodiments of the invention have been described above for purposes of illustrating the details thereof and to enable one of ordinary skill in the art to make and use the invention. The details and features of the disclosed embodiment[s] are not intended to be limiting, as many variations and modifications will be readily apparent to those of skill in the art. Accordingly, the scope of the present disclosure is intended to be interpreted broadly and to include all variations and modifications coming within the scope and spirit of the appended claims and their legal equivalents.

1. A system for managing a loyalty reward program, comprising:
a server module configured to receive transaction requests from a plurality of merchant devices, each transaction request including transaction data comprising a customer identifier, a merchant identifier, a tender selection and an amount;
a transaction processing module operatively coupled with the server module and configured to process the transaction data to identify a currency amount and at least one of a redemption amount as a function of the customer identifier and a reward amount as a function of the tender selection;
a financial account access module configured to access a financial account associated with the customer identifier and debit the currency amount from the financial account; and
a reward allocation module configured to access a loyalty account associated with the customer identifier and apply a credit to the loyalty account based on the reward amount and the tender selection and apply a debit to the loyalty account based on the redemption amount.

2. The system of claim 1, wherein the loyalty account is a merchant-specific account associated with a merchant.

3. The system of claim 1, wherein the server module is configured to present a dashboard to a customer, the dashboard including a history of transactions and a plurality of redemption options for the customer identifier.

4. The system of claim 1, wherein the credit includes a percentage of the amount.

5. The system of claim 1, further comprising an authentication module configured to perform an authentication process based on a candidate password submitted by a user.

6. The system of claim 1, wherein the tender selection is one of a checking account, savings account, credit card, debit card and loyalty reward account associated with a financial account.
